(19) United States
(12) Patent Application Publication
(10) Pub. No.: US 2022/0279815 A1
(43) Pub. Date: Sep. 8, 2022

(54) PROTEIN POWDER COMPRISING NON-COAGULATED PROTEIN

(71) Applicant: REPASCO AB, Lomma (SE)

(72) Inventors: Tomas Leufstedt, Lomma (SE); Henrik Hjalmarsson, Lomma (SE); Martin Lundin, Glumslöv (SE)

(21) Appl. No.: 17/632,289

(22) PCT Filed: Jul. 21, 2020
(86) PCT No.: PCT/EP2020/070538

§ 371 Date: Feb. 2, 2022

(30) Foreign Application Priority Data
Aug. 5, 2019 (SE) 1950914-0

(51) Int. Cl. A23J 3/04

(52) U.S. Cl. CPC A23J 3/04

(57) ABSTRACT

Described is a method for manufacturing a protein powder containing at least partly non-coagulated proteins. The method includes the steps of grinding a solid proteinaceous raw material to obtain a solid ground protein, heating the ground protein to a temperature T below its coagulation temperature T_{P} such that fat contained in the ground protein melts, separating the melted fat from the ground protein to obtain a defatted protein fraction, and drying the defatted protein fraction in a drier at a temperature T_{D}, whereby a protein powder comprising at least partly non-coagulated proteins is formed. Also described is a protein powder that includes at least partly non-coagulated proteins obtained by said method, and a use of a at least partly non-coagulated protein powder in a foodstuff for humans or animals, such as animal feed.

### TECHNICAL FIELD OF THE INVENTION

The invention relates to a method for manufacturing a protein powder comprising at least partly non-coagulated proteins and a protein powder comprising non-coagulated proteins manufactured by said method. The invention further relates to the use of said protein powder in food or foodstuff, such as animal feed.

### BACKGROUND

Animal proteins can be used as a raw material in different proteinaceous products, which often act as the main ingredient in for instance animal feed and other foodstuff. Processing operations involving animal proteins also render leftovers, which can be used as a raw material and be turned into different meat and bone meals used as basic ingredients in fish meals or animal feed. The protein products formed from animal proteins are often in the form of e.g. a powder, which is mixed with further ingredients and compacted into pellets, granules, or pieces in wet food. Alternatively, the protein products are used as protein boosters in foodstuff edible by humans.

A proteinaceous raw material such as poultry, beef, fish or pork meat may be ground and suspended or dissolved in an aqueous slurry/suspension or solution. Subsequently, the liquid is heated above 90° C. to melt and remove the fat contained in the raw material. The proteins in the suspension will also become hydrolysed and coagulate. Alternatively, enzymes are added to hydrolyse the proteins enzymatically or the pH is regulated to treat the proteins, but this is a very costly process. Fat is separated from the suspension and the suspension is dried. Drying is performed by for instance contact drying or using other drying methods known in the art such as freeze drying or turbo drying. Optionally, additional oils are added to the product and the product is partially dried such that the final product comprises a certain percentage water.

A protein product comprising 45-65 wt % hydrolysed proteins, 20-35 wt % oil and 10-15 wt % moisture is disclosed in WO 9118520 A1. Further prior art is disclosed in for instance WO 2007071403 A1, WO 02065848, US20110129565 A1 and WO 2015050294 A1.

However, in order to form pellets from the protein products, additional binders such as starch often has to be added to the products to form a solid product that does not disintegrate. This in turn lowers the nutritional value of the product, since the protein concentration is hard to maintain at a high level when additives are added. Furthermore, current proteinaceous products often have a foul smell. An object of the present invention is to overcome or at least mitigate these problems.

### SUMMARY OF THE INVENTION

According to a first aspect of the invention, the above and other objects of the invention are achieved, in full or at least in part, by a method as defined by claim 1. According to this claim the above object is achieved by a method for manufacturing a protein powder comprising at least partly non-coagulated proteins. The method comprises the steps of:
grinding a solid proteinaceous raw material to obtain a solid ground protein;
heating the ground protein to a temperature T below its coagulation temperature T_{P} such that fat contained in the ground protein melts;
separating the melted fat from the ground protein to obtain a defatted protein fraction; and
drying the defatted protein fraction in a drier at a temperature T_{D}, whereby a protein powder comprising at least partly non-coagulated proteins is formed.

This method is advantageous since the grinding allow for easy pumping of the protein through the manufacturing process. In addition, the grinding facilitates even heating in the subsequent method step. The heating is especially beneficial since the fat is melted to enable separation of the fat from the ground protein while the proteins remain non-coagulated.

According to a second aspect, there is provided a protein powder comprising at least partly non-coagulated proteins obtained by the method disclosed above.

According to a third aspect, there is provided a non-coagulated protein powder, comprising at least partly non-coagulated proteins and has a moisture content of 12 wt % or less, and wherein the protein powder comprising at least partly non-coagulated proteins (11) has a gel strength (g·f) of at least 10, such as at least 20, 30, 40, 50 or 60.

According to a fourth aspect, there is provided the use of a protein powder comprising at least partly non-coagulated proteins in a foodstuff for humans or animals, such as animal feed.

Other objectives, features and advantages of the present invention will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

As used herein, the term “comprising” and variations of this term are not intended to exclude other additives, components, integers or steps.

### BRIEF DESCRIPTION OF THE DRAWINGS

Further objects, features and advantages will appear from the following detailed description, with reference being made to the accompanying drawings, in which:

FIG. 1 shows a system for manufacturing a non-coagulated protein powder;

FIG. 2 is a flowchart illustrating a method for manufacturing a non-coagulated protein powder; and

FIG. 3 shows a test result from an emulsion test performed on a non-coagulated protein powder and a control sample comprising coagulated proteins.

### DETAILED DESCRIPTION

The invention relates to a method for manufacturing a protein powder comprising at least partly non-coagulated proteins and a protein powder comprising at least partly non-coagulated proteins manufactured by the method thereof. The invention further relates to the use of said protein powder in foodstuffs, such as animal feed. The protein powder comprising at least partly non-coagulated proteins is also referred to as a non-coagulated protein powder herein.

In short, the invention is based on—inter alia—the idea that a protein powder comprising proteins which have not been denatured or coagulated is advantageous compared to a protein powder comprising proteins which have coagulated during the manufacturing process. The non-coagulated protein powder will enable easy formation of pellets for e.g. pet foods without the need of additives such as binders. Consequently, the non-coagulated protein powder maintains its original nutritional levels and the powdered protein product facilitates the regulation of the protein concentration in a finished pet food. In addition, the non-coagulated protein powder has a very neutral smell, which is an advantage compared to currently existing protein powder products. The non-coagulated protein powder is obtained by controlling the temperatures during the manufacturing method.

Proteins are macromolecules consisting of long chains of amino acids wound into a certain three dimensional structure. There are different ways to disturb the three dimensional structure of proteins. The addition of heat, acid or and mechanical force (such as whisking an egg) will cause hydrogen bonds in the proteins to be broken, resulting in an “unwinding” of the structure of the proteins. When the proteins are unwound, they have been altered from their natural state and are considered denatured. Once denatured, the proteins are free to interact with other chemicals or to recombine with itself to coagulate. This process occurs for instance when an egg is boiled or when a piece of meat is fried.

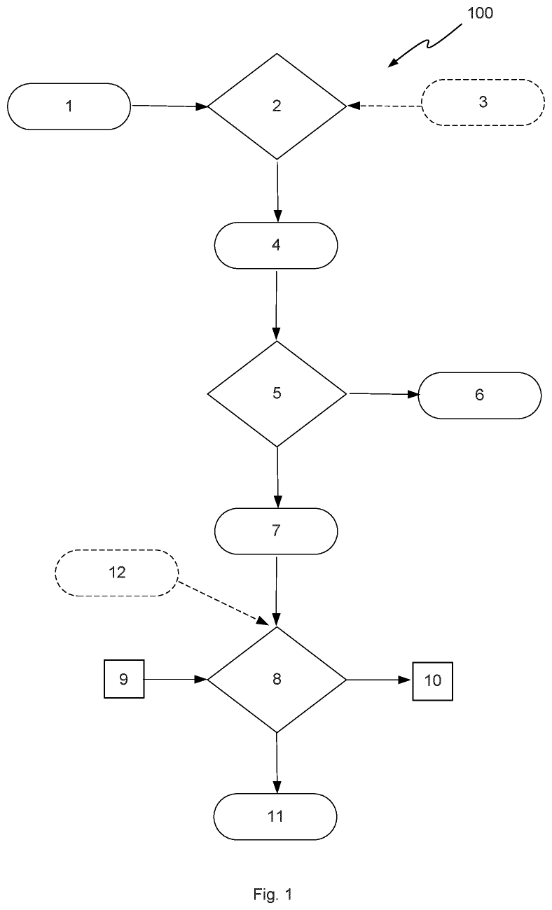

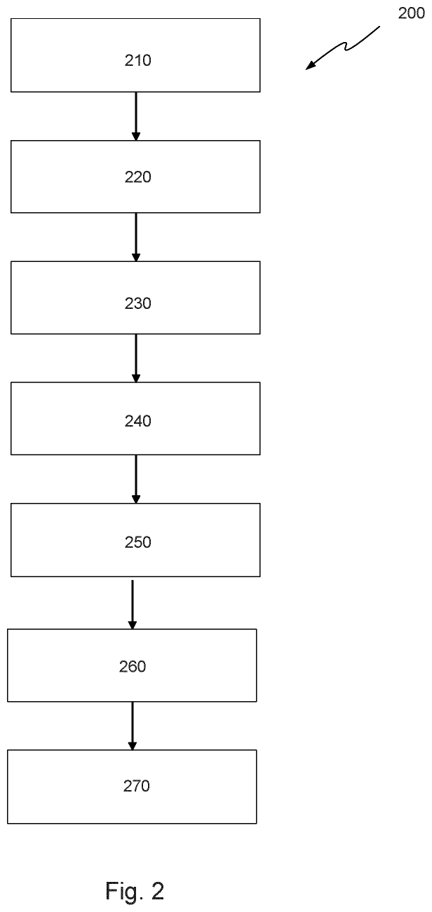

One embodiment of the invention will now be described in relation to FIGS. 1 and 2. A protein powder comprising at least partly non-coagulated proteins 11 disclosed herein is produced using a system 100 shown in FIG. 1 and is manufactured according to a method 200 shown in FIG. 2. The protein powder comprising at least partly non-coagulated proteins 11 is also referred to as a non-coagulated protein powder 11 herein.

With reference to the system 100 shown in FIG. 1, a solid proteinaceous raw material 1 and optionally antioxidants 3 are added to a grinder 2. An obtained minced protein 4, also herein referred to as a ground protein 4, is then transferred to a heater 5 to melt fat 6 contained in the ground protein 4. The fat 6 is separated and a defatted protein fraction 7 is obtained. The defatted protein fraction 7 is transferred to a drier 8, where optionally also additional ingredients 12, such as potatoes, may be added. Inlet air 9 is fed into the drier 8 and exit air 10 exits the drier 8. The defatted protein fraction 7 is dried in the drier 8 resulting in the formation of a protein powder comprising non-coagulated proteins 11.

The method 200 for manufacturing the non-coagulated protein powder 11 will now be described more in details with reference to FIGS. 1 and 2. The method 200 comprises a first step of grinding 210 the solid proteinaceous raw material 1 in the grinder 2. The proteinaceous raw material 1 may be poultry, pork, beef or fish or a combination thereof, and it may be leftovers from other animal protein processes. Preferably, the proteinaceous raw material 1 does not comprise feathers or blood. The proteinaceous raw material 1 has a fat content of at least 40%, such as at least 20%, based on dry substance, (water excluded).

Optionally, antioxidants 3 may also be added to the proteinaceous raw material 1 before or during grinding 210. The proteinaceous raw material 1 is ground to a minced protein 4, having a particle size of about 5 to 20 mm, more preferably 7 to 15 mm, most preferred 10 mm. Hence, the raw material 1 should be ground during the grinding step 210 to a particle size of below 20 mm, preferably below 15 mm, most preferred below 10 mm. However, the proteinaceous raw material 1 may be ground to other dimensions depending on the proteinaceous raw material 1 and the equipment used.

Next, the ground protein 4 is optionally pumped 220 and optionally a step of sizing 230 occurs where the minced protein 4 may be further ground to even smaller dimensions than in the first grinding step 210.

The grinding 210 is advantageous since ground protein 4 is more easily pumped through the system, and it facilitates the removal of fat from the product.

Subsequently, the minced protein 4 is transferred to a heater 5. The minced protein 4 is heated 240 in the heater 5 to a temperature T below a protein denaturation and coagulation temperature T_{P} of the minced protein 4. Hence, the temperature T may vary depending on what proteinaceous raw material 1 used for each process using the method 200, since the protein denaturation and coagulation temperature T_{P} varies between different proteins.

The minced protein 4 is heated 240 in the heater 5 to a temperature T of about 35 to 90° C., more preferably between about 40 to 75° C., such as 40 to 60° C., and most preferred not above 45° C. The highest temperature T used should be below the coagulation temperature T_{P} of the used raw material 1. Most proteins start to coagulate at a temperature T_{P} of about 50° C. Hence, the temperature T should not be higher than 90° C., such as below, 90° C., such as below 70° C., such as below 60° C., and most preferably below 50° C. The lowest possible temperature 35° C. is suitable since it is sufficiently warm to melt the fat 6 in the ground protein 4.

Preferably, the heater 5 is a scraped heat exchanger. The scraped heat exchanger keeps the minced protein 4 in motion, facilitating an even heating throughout the minced protein 4. However, any heater 5 known in the art may be used. The heating 240 may use steam to heat the ground proteins 4. Since the raw protein 1 has been minced, it is easier to heat the ground protein 4 evenly. The fact that the raw protein 1 has been minced also makes the heating 240 process faster.

During the heating step 240, the fat 6 comprised in the minced protein 4 will melt due to the elevated temperature T. Hence, the heating step 240 is followed by a separation step 250 where melted liquid fat 6 is separated 250 from the ground proteins 4. The minced proteins 4 are still solid. The liquid fat 6 may be separated 250 from the solid ground protein 4 by various known separation means, preferably by decanting the fat 6. It is also possible to use a screw press, but a decanter centrifuge is preferred for system integration purposes. In this way, the liquid fat 6 can be treated post separation 250.

After the fat 6 has been separated 250 from the ground protein 4, a defatted protein fraction 7 is obtained. Since the heating temperature T in the heating step 240 is below the protein coagulation temperature T_{P}, the defatted protein fraction 7 remains non-coagulated an non-denatured.

Subsequently, the defatted protein fraction 7 is transferred to a drier 8. The drier 8 is preferably hot-air drier, and most preferred a flash-drier. A flash-drier uses hot air and short retention times. When the defatted protein fraction 7 enters the heater 5, it has substantially the same temperature T as held in the heater 5. The defatted protein fraction 7 is placed in the drier 8, and inlet air 9 having a drying temperature T_{D} of approximately 150 to 350° C., such as 200 to 300° C., preferably 230 to 250° C., is fed into the drier 8 drying 270 the defatted protein fraction 7. The temperature T_{D} should hence be selected to be below 350° C., such as below 280° C., most preferred below 250° C. Exit air 10 from the drier 8 has a temperature of approximately 50 to 100° C., but preferably 70 to 80° C.

During the drying step 270, moisture contained in the defatted protein fraction 7 is extracted and removed from the defatted protein fraction 7 to obtain a protein powder comprising non-coagulated proteins 11. The drying 270 taking place in the drier 8 is quick and efficient, such that water/moisture is extracted but the defatted protein fraction 7 remain un-denatured and non-coagulated. The heat in the drier 8 transforms the defatted protein fraction 7 into a fine non-coagulated protein powder 11.

The non-coagulated protein powder 11 can thereafter be cooled, packaged and delivered to other industries or directly be transformed into pellets, granules or e.g. pet food. An advantage is that the non-coagulated protein powder 11 can be mixed with a liquid, such as water, and be heated to induce coagulation of the proteins in the powder 11. The mixture of the powder 11 and liquid upon heating forms a “muffin” like solid without the need of additives or binders.

The finished non-coagulated protein powder 11 has a moisture content of less than 12%, such as preferably 5 to 6%. A moisture content higher than 12% decreases the shelf life of the protein powder 11. Since the heating temperature Tin the heating step 240 is below the protein coagulation temperature T_{P}, the defatted protein fraction 7 remains non-coagulated an non-denatured. This results in a non-coagulated protein powder 11 being purely a protein powder without any additives, even if antioxidants may be used.

Known methods use defatting temperatures higher than the coagulation temperature T_{P} resulting in protein products (for instance powders) where the proteins have coagulated during the manufacturing process. A coagulated protein powder has deteriorated binding properties resulting in the need for binders and/or other additives to form pellets or granules from the powder. This means that when producing for instance pet food from the powder, the protein content in the pet food will be diluted when forming pellets or cakes from the powder.

With the non-coagulated protein powder 11 disclosed herein, animal feed can be produced with a much higher water binding capacity, purity and protein concentration. This is due to that coagulation seemingly affects the gelatinization properties of the product. In addition, the water binding properties are also affected by the coagulation.

The water binding capacity of the non-coagulated protein powder 11 may be higher than 1:1.8 (g powder:g water), such as higher than 1:2.0 (g powder:g water), such as higher than 1:2.5 (g powder:g water) (cf. Example 1).

The peak gel strength of a gelatine gel type of the non-coagulated protein powder 11 is preferably at least 10 g·f, such as at least 20 g·f, such as at least 30 g·f, or at least 40 g·f (cf. Example 2). The peak gel strength of a particle gel type of the non-coagulated protein powder 11 is preferably at least 10 g·f, such as at least 20 g·f, such as at least 30 g·f, such as at least 40 g·f, such as at least 50 g·f or at least 60 g·f (cf. Example 2). Preferably, the gel strength of the protein powder comprising non-coagulated proteins 11 is at least 40 g·f.

The peak compression force of an emulsion comprising one part of the non-coagulated protein powder 11, seven parts of water and seven parts of melted hard fat is preferably at least 200 g·f, such as higher than 500 g·f, such as higher than 1000 g·f, such as higher than 1500 g·f, or higher than 1700 g·f (cf. Example 3).

Optionally, additional ingredients 12 may be added 260 to the defatted protein fraction 7 in the drier 8. Such additional ingredients 12 can be for instance a source of starch, such as potatoes. The drying 270 is then performed in the same way as described above. The addition step 260 enables a voluntary dilution of the protein content of the finished non-coagulated protein powder 11. The optional addition step 260 further allows for voluntary addition of other nutritional supplements, i.e. vitamins, minerals or antioxidants. In order for the drier 8 to function properly, the fat content of the ingoing solids in the drier 8 needs to be sufficiently low. Hence, if additional ingredients 12 such as potatoes are added, the heating step 240 and/or the separation step 250 may be excluded.

### Experiments

Different experiments have been performed in order to test water binding properties, gel strength and peak compression force. All experiments were performed using a sample of the non-coagulated protein powder disclosed herein (Repasco) and a control sample (Comp 1). The control sample comprises coagulated proteins. The results show clear functional advantages of the non-coagulated protein powder compared to the control samples.

### Example 1—Water Binding Capacity

Tests were performed using the non-coagulated protein powder disclosed herein (Repasco) and a control sample (Comp 1). Tests were also performed on samples comprising 2% salt (NaCl).

The samples were weighed into excess water (1:20), and the tubes comprising the samples were centrifuged at 3000 rpm. The ratio between the initial weight of the sample and the bound water on the sample after discarding supernatant is the water binding ratio.

The results are shown in Table 1 below. It is clear from the results that the non-coagulated protein powder disclosed herein (Repasco) has higher water binding capacity and there is a slight improvement of the water-binding capacity in the non-coagulated protein powder sample comprising 2% salt (NaCl).

TABLE 1
the test results from the Water binding Capacity test.

| | Water binding | |
|---|---|---|
| Sample | (g/g sample) | NaCl |
| Repasco | 2.87 | 0% salt |
| Repasco | 2.96 | 2% salt |
| Comp 1 | 1.58 | 0% salt |
| Comp 1 | 1.69 | 2% salt |

### Example 2—Gel Strength

Gels from the non-coagulated protein powder disclosed herein (Repasco) and a control sample (Comp 1) were prepared by dispersing a test-sample in water with 2% NaCl at a ratio of 1 part protein and 7 parts water. After dispersing, the tubes were placed in a water-bath for 20 minutes at 80° C. After heat gelling, the gels were cooled in a fridge at 5° C. The gels were measured on strength the next day. Each tube obtained a gelatinous layer and a particle gel layer, which were both tested.

In this case the gelatinous layer and the particle gel have been measured on strength with a Texture Analyzer by compression testing.

The results are shown in Table 2. The gels show clear differences—with the control samples (Comp 1) having a very weak gelatinous top layer. The peak gel strength of both the gelatinous layer and the particle gel of the non-coagulated protein powder disclosed herein (Repasco) are much higher than that of the control sample. The test results demonstrates a better functionality of the non-coagulated protein powder disclosed herein compared to the control samples.

TABLE 2
the test results from the Gel Strength test.

| | Peak Gel stength | |
|---|---|---|
| Sample | (g · f) | Gel type |
| Repasco | 42.2 | gelatine |
| Repasco | 63.5 | particle |
| Comp 1 | 2.2 | gelatine |
| Comp 1 | 2.5 | particle |

### Example 3—Emulsion Testing

For the emulsion-test, a typical 1:7:7 emulsion was prepared from the non-coagulated protein powder disclosed herein (Repasco) and a control sample (Comp 1). The 1:7:7 emulsion was prepared using: 1 part protein sample, 7 parts of water and 7 parts of molten hard fat (‘Ossewit’).

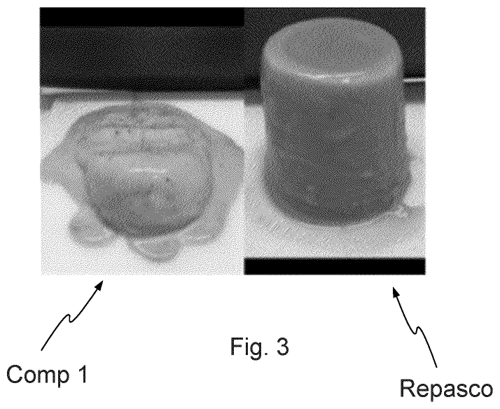

Each warm suspension was vigorously stirred with a high speed mixer to prepare a homogeneous emulsion. Each emulsion was then poured into test-cups and the emulsions were left to settle in the fridge overnight. FIG. 3 shows the marked difference in results. The sample to the left is the control samples Comp 1 and the sample to the right comprises the non-coagulated protein powder (Repasco). The non-coagulated protein powder formed a much firmer emulsion as seen in FIG. 3.

Table 3 below also shows the emulsion strength as measured on a Texture Analyzer, which shows that the peak compression force of the emulsion formed from the non-coagulated protein powder is much higher than that of the control sample Comp 1.

TABLE 3
shows the compression force of the prepared 1:7:7
emulsions formed from the non-coagulated protein
powder (Repasco) and the control sample (Comp 1).

| | Peak Compression |
|---|---|
| Sample | (g · f) |
| Repasco | 1749 |
| Comp 1 | 83 |

1. A method for manufacturing a protein powder comprising at least partly non-coagulated proteins, wherein the method comprises the steps of:
grinding a proteinaceous raw material to obtain a solid ground protein;
heating the ground protein to a temperature T below its coagulation temperature T_{P} such that fat contained in the ground protein melts;
separating the melted fat from the ground protein to obtain a defatted protein fraction; and
drying the defatted protein fraction in a drier at a temperature T_{D}, whereby a protein powder comprising at least partly non-coagulated proteins is formed.

2. The method according to claim 1, wherein the solid proteinaceous raw material comprises an animal protein.

3. The method according to claim 1, wherein the temperature T is between 35 to 90° C.

4. The method according to claim 1, wherein the temperature T is below, 90° C.

5. The method according to claim 1, wherein the drier is a flash-drier.

6. The method according to claim 1, wherein the temperature T_{D} is between 150 to 350° C.

7. The method according to claim 1, wherein the temperature T_{D} is below 350° C.

8. The method according to claim 1, wherein the raw material is ground during the grinding step to a particle size of between 5 to 20 mm.

9. The method according to claim 1, wherein the raw material is ground during the grinding step to a particle size of below 20 mm.

10. The method according to claim 1, wherein the method further comprises a step of pumping the ground protein-after the step of grinding and before the step of heating the ground protein.

11. The method according to claim 1, wherein the method further comprises a step of sizing the ground protein to further grind the ground protein after the step of grinding and before the step of heating the ground protein.

12. The method according to claim 1, wherein the melted fat is separated by decantation.

13. The method according to claim 1, wherein before the step of drying, the method further comprises a step of adding at least one additional ingredient.

14. A protein powder comprising at least partly non-coagulated proteins produced by the method according to claim 1.

15. The non-coagulated protein powder according to claim 14, wherein the non-coagulated protein powder has a moisture content of 12 wt % or less.

16. The non-coagulated protein powder according to claim 15, wherein the non-coagulated protein powder has a moisture content of between 5 and 6 wt %.

17. The non-coagulated protein powder according to claim 14, wherein the non-coagulated protein powder has a gel strength (g·f) of at least 10.

18. The non-coagulated protein powder according to claim 14, wherein the non-coagulated protein powder has a water binding capacity ratio of non-coagulated protein powder and water higher than 1:1.8.

19. The non-coagulated protein powder according to claim 14, wherein an emulsion comprising one part of the non-coagulated protein powder, seven parts of water and seven parts of molten hard fat, has a peak compression force (g·f) of 200 or more.

20. A non-coagulated protein powder, comprising at least partly non-coagulated proteins which has a moisture content of 12 wt % or less, and wherein the protein powder comprising at least partly non-coagulated proteins has a gel strength (g·f) of at least 10.

21. (canceled)
